(19) United States
(12) Patent Application Publication
(10) Pub. No.: US 2015/0100677 A1
(43) Pub. Date: Apr. 9, 2015

(54) MANAGING SERVER SYSTEM, AND CONTROL METHOD FOR THE SAME

(71) Applicant: CANON KABUSHIKI KAISHA, Tokyo (JP)

(72) Inventor: Tetsuya Matsumoto, Kawasaki-shi (JP)

(21) Appl. No.: 14/502,247

(22) Filed: Sep. 30, 2014

(30) Foreign Application Priority Data
Oct. 8, 2013 (JP) 2013-211163

(51) Int. Cl. H04L 12/24; H04L 29/08

(52) U.S. Cl. CPC H04L 41/50; H04L 67/10
USPC 709/223

(57) ABSTRACT

A managing server system configured to manage operational information of a network device includes a managing unit configured to manage each of a plurality of groups by a tenant, and a setting unit configured to set whether an object to be processed is a tenant unit or a group unit in relation to each of a plurality of functions provided by the managing server system. The managing unit manages a site that belongs to one group of the plurality of groups by a tenant that is different from the group. The site that is managed as the tenant is not the object to be processed in a function in which the object to be processed is the group unit, otherwise the site that is managed as the tenant is the object to be processed in a function in which the object to be processed is the tenant unit.

### BACKGROUND OF THE INVENTION

1. Field of the Invention

The present invention relates to a management system configured to manage tenants in a hierarchical configuration and to display a list of information regarding a tenant that is an object to be managed, and to a control method for the system.

2. Description of the Related Art

A management system has been provided that is configured to use a cloud system or the like to manage customer data with reference to a tenant unit that is a dedicated area for each customer. The management system controls access to allow customer user access only tenant data that belongs to that customer. The management system is used to provide a service in which a service provider manages customer data that is consigned from a customer. The management system also grants an access right to a service provider to enable access to customer tenant data to be managed by the service provider in order to provide those services.

With increase in the consignment of duties, the service provider manages large scale customer having a plurality of group companies and a plurality of sites. In this case, a single service provider experiences difficulty in managing the customer. As a result, the service provider may consign duties to another service provider. For the consignment of duties to another service provider, the companies or the sites of the customer to be consigned are divided into separate tenants. Then, an access right to the other service provider is granted in relation to the divided tenants. In this manner, the respective service providers can clearly distinguish the range of data that can be accessed and the range of the customer to be managed to enable customer management. Japanese Patent Laid-Open No. 2011-113422 discloses a technique for a customer information managing server that manages customer information. With this technique, the managing server extracts customer information that is managed with reference to a customer ID based on a keyword to thereby generate and output a customer list.

The managing server disclosed in Japanese Patent Laid-Open No. 2011-113422 generates and outputs a customer list with reference to the customer ID unit. However, the managing server disclosed in Japanese Patent Laid-Open No. 2011-113422 does not assume circumstances in which duties are consigned to another service provider. A customer list with reference to a tenant unit is sufficient for a function in which a service provider manages and performs operations in relation to a customer. However, it is desirable to handle a tenant at a site that has been divided for the service provider to consign duties as tenant information of the company prior to division in relation to a report function in order to enable the customer to peruse information. For this reason, the customer list with reference to a tenant unit is not adapted to such a function.

### SUMMARY OF THE INVENTION

The present invention provides a managing server system which can generate a list with reference to a suitable unit corresponding to a service function to be provided.

According to an aspect of the present invention, an information processing system configured to manage operational information of a network device that is installed on a customer network is provided that includes a managing unit configured to manage each of a plurality of groups, that belong to the customer, by a tenant, and a setting unit configured to set whether an object to be processed is a tenant unit or a group unit in relation to each of a plurality of functions provided by the managing server system, wherein the managing unit manages a site that belongs to one group of the plurality of groups by a tenant that is different from the group, and wherein, in accordance with the setting, the site that is managed as the tenant is not the object to be processed in a function in which the object to be processed is the group unit, otherwise the site that is managed as the tenant is the object to be processed in a function in which the object to be processed is the tenant unit.

According to managing server system of the present invention, a list can be generated with reference to a suitable unit corresponding to a provided service function.

Further features of the present invention will become apparent from the following description of exemplary embodiments (with reference to the attached drawings).

### BRIEF DESCRIPTION OF THE DRAWINGS

FIG. 1 is a diagram illustrating a configuration of a tenant management system according to one embodiment of the present invention.

FIG. 2 is a block diagram illustrating an example of the internal configuration of the managing server and a host computer.

FIG. 3 is a block diagram illustrating an example of a function configuration of the host computer.

FIG. 4 is a block diagram illustrating an example of the function configuration of the managing server.

FIGS. 5A to 5C are diagrams illustrating examples of a table that is managed by a tenant information managing unit.

FIG. 6 is a diagram illustrating an example of a hierarchical structure by tenant type.

FIG. 7 is a diagram illustrating an example of the hierarchical structure of a tenant.

FIGS. 8A and 8B are diagrams illustrating examples of a table that is managed by a group information managing unit.

FIGS. 9A to 9C are diagrams illustrating examples of the hierarchical structure of a site group in each tenant.

FIGS. 10A to 10C are diagrams illustrating examples of the hierarchical structure of an organization group in each tenant.

FIGS. 11A and 11B are diagrams illustrating examples of a table that is managed by a device information managing unit.

FIG. 12 is a diagram illustrating an example of a table that is managed by a list creating unit.

FIG. 13 is a diagram illustrating an example of a tenant information change screen.

FIG. 14 is a flowchart illustrating an example of a settable tenant type determination processing.

FIG. 15 is a flowchart illustrating an example of a type change determination processing for a subordinate tenant.

FIG. 16 is a flowchart illustrating an example of a processing sequence for list creation processing.

FIG. 17 is a flowchart illustrating an example of tenant list creation processing.

FIG. 18 is a flowchart illustrating an example of subordinate tenant data acquisition processing.

FIG. 19 is a flowchart illustrating an example of data creation processing.

FIG. 20A is a diagram illustrating an example of a tenant list display for a tenant management function.

FIG. 20B is a diagram illustrating an example of a tenant list display for a report function by company.

FIG. 21 is a flowchart illustrating an example of group list creation processing.

FIG. 22 is a flowchart illustrating an example of subordinate tenant data acquisition processing.

FIG. 23 is a flowchart illustrating an example of group hierarchical level change processing.

FIG. 24 is a diagram illustrating an example of a group list display for a device group (site) management function for a plurality of tenants.

FIG. 25 is a diagram illustrating an example of the group list display for the report function by site for the plurality of tenants.

FIG. 26A is a diagram illustrating an example of the group list display for a device group (organization) management function for a plurality of tenants.

FIG. 26B is a diagram illustrating an example of the group list display for the report function by organization for a plurality of companies.

### DESCRIPTION OF THE EMBODIMENTS

### First Embodiment

### Description of System Configuration

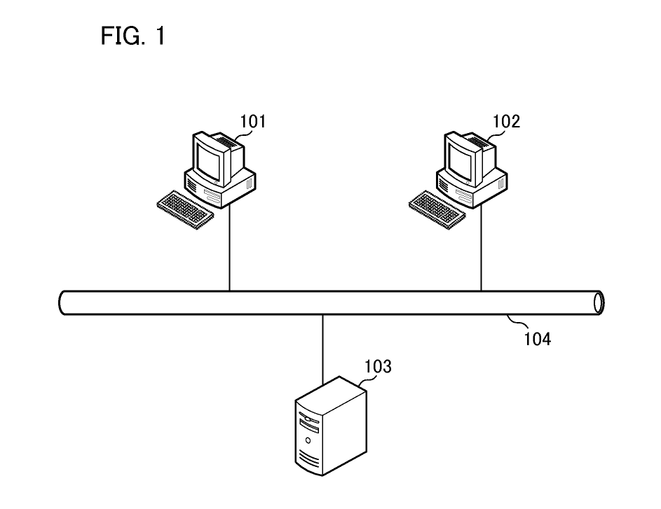

FIG. 1 is a schematic diagram illustrating a configuration of a tenant management system according to one embodiment of the present invention. The tenant management system includes host computers 101 and 102, and a managing server 103. In FIG. 1, the host computer 101 is used by a user of a service provider. The user of the service provider performs operations such as data management of customer tenants retained in the managing server 103, commands to create a report for provision to a customer, or the like. Furthermore, the service provider user records the customer tenant(s) in the managing server, and changes or sets the customer tenant information. Although not illustrated in the drawings, a plurality of host computers 101 is available to each service provider or service provider user.

The host computer 102 is used by a customer user. The customer user performs customer tenant data management retained in the managing server 103 and performs operations such as acquisition and perusal of a report provided by a service provider, or the like. Although not illustrated in the drawings, a plurality of host computers 102 is available to each customer or customer user.

The managing server 103 manages a respective plurality of groups such as companies belonging to the customer, or the like, with reference to a customer tenant, and manages the data for that customer tenant. More specifically, the managing server manages the operational information of the network device such as a printer or the like that is installed on the customer network. Furthermore, when accessed by a customer user, control is implemented to only enable access to the data belonging to the customer tenant. Furthermore, when accessed by a service provider user, control is implemented to only enable access to data of a customer tenant that is permitted to that service provider user. In the present embodiment, the managing server 103 is configured as a single server. However, the managing server 103 may be divided into a plurality of managing servers for example with reference to the functional constituent units (for example, storage) of the managing server, and thereby configured to function as a managing server system. In addition, the host computers 101 and 102, and the managing server 103 are connected to enable intercommunication by a network 104 by use of a known technique such as the Internet or a LAN, or the like.

### Computer Internal Configuration

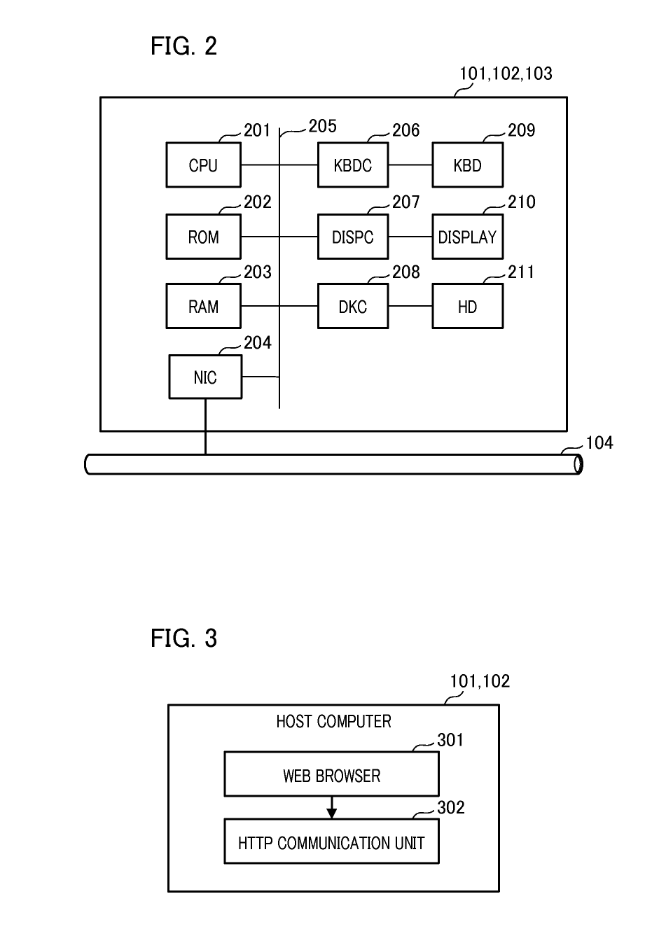

FIG. 2 is a block diagram illustrating an example of the internal configuration of an information processing apparatus that configures the host computers 101 and 102, and the managing server 103. The host computers 101 and 102, and the managing server 103 are provided with a CPU 201 to a HD 211. The CPU 201 executes integral control of respective hardware connected by a system bus 205. Furthermore, the CPU 201 executes software stored in the hard disk (HD) 211 that is a storage apparatus, or a ROM 202. A RAM 203 functions as a main memory of the CPU 201, a work area, or the like. CPU is an abbreviation for central processing unit, ROM is an abbreviation for read only memory. RAM is an abbreviation for random access memory.

A network interface card (NIC) 204 performs bidirectional data exchange with another node through the network 104. A keyboard controller (KBDC) 206 controls command input from a keyboard (KBD) 209 that is provided to the PC. A display controller (DISPC) 207 controls the display of a display module (DISPLAY) 210 that is configured as a liquid crystal display or the like. A disk controller (DKC) 208 controls the hard disk (HD) 211 that is a large capacity storage apparatus.

### Functional Configuration of Host Computer

FIG. 3 is a block diagram illustrating an example of the function configuration of the host computers 101 and 102 illustrated in FIG. 1. The host computer includes a Web browser 301 and an HTTP communication unit 302. The Web browser 301 interprets HTML data, performs screen rendering to the display module 210, receives user operations from a keyboard or the like, and sends a request to the HTTP communication unit 302. The HTTP communication unit 302 receives a communication request from the Web browser, communicates with the managing server 103 through the NIC 204 by use of an HTTP or HTTPS protocol, requests a Web page, and receives Web page data, or the like.

### Functional Configuration of Managing server

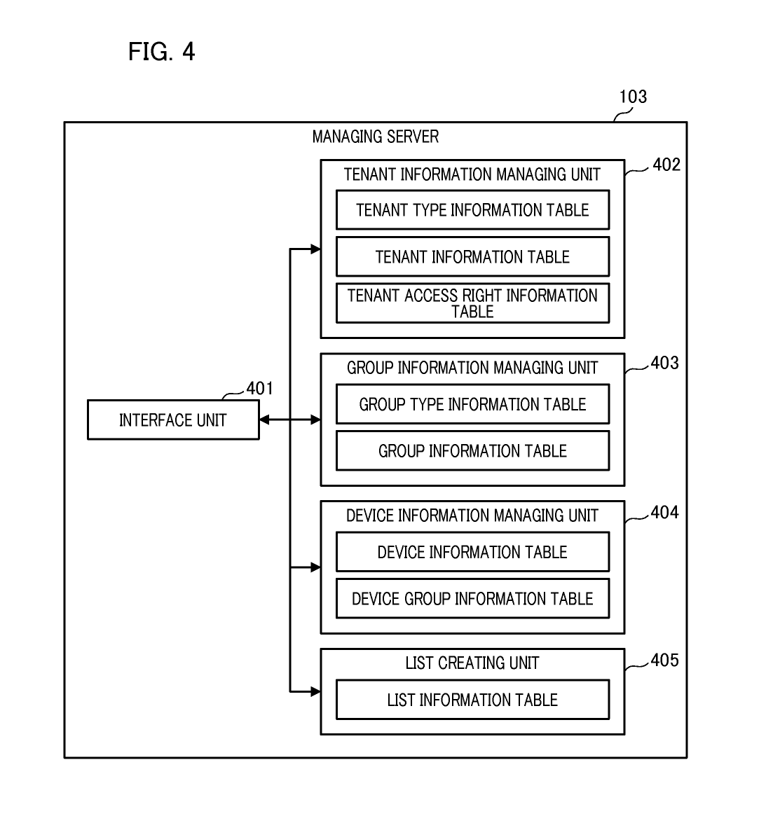

FIG. 4 is a block diagram illustrating an example of the function configuration of the managing server 103 illustrated in FIG. 1. The managing server 103 includes an interface unit 401, a tenant information managing unit 402, a group information managing unit 403, a device information managing unit 404, and a list creating unit 405. The interface unit 401 communicates with the host computer 101 through the NIC 204 illustrated in FIG. 2 and the network 104. The interface unit 401 determines the access permission state or the like upon receipt of a request from the host computer to a Web page in HTTP or HTTPS, and returns the HTML data.

The tenant information managing unit 402 includes a tenant type information table, a tenant information table, and a tenant access right information table, and retains information related to a tenant. The group information managing unit 403 includes a group type information table and a group information table, and stores information related to the grouping of data for a device or the like in the tenant. A device information managing unit 404 includes a device information table and a device group information table, and stores information related to a device. The list creating unit 405 includes a list information table, and creates a group list or a tenant list for display upon receipt of a command from the host computers 101 and 102 for list display or the like of a group or a tenant or the like.

### Tenant Type Information Table

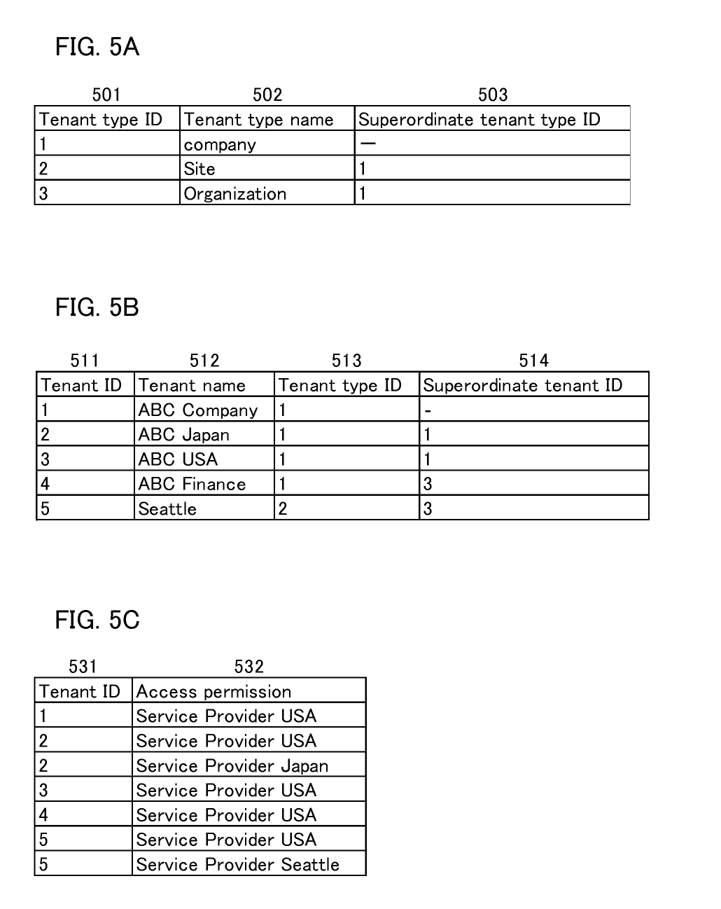

FIG. 5A is a diagram illustrating a tenant type information table that illustrates an example of a configuration of tenant type information managed by the tenant information managing unit 402. A tenant type indicates the type of the tenant such as, for example, a tenant created with reference to the unit “company” or a tenant created with reference to the unit “site”. The tenant type also includes a hierarchical structure. For example, when a site forms a part of a company, the tenant type of the site of is a tenant type that is subordinate to the company tenant type. The table also manages information indicating a hierarchical relationship between tenant types as tenant type information.

The tenant type information table illustrated in FIG. 5A is configured form a tenant type ID 501, a tenant type name 502, and a superordinate tenant type ID 503. The column for tenant type ID 501 indicates the ID that uniquely identifies the tenant type in the system. The column for tenant type name 502 indicates the tenant type name. The column for superordinate tenant type ID 503 indicates the ID of the tenant type in the superordinate hierarchical level. The respective setting values for the tenant type information table may be set or changed from an input apparatus of the managing server 103.

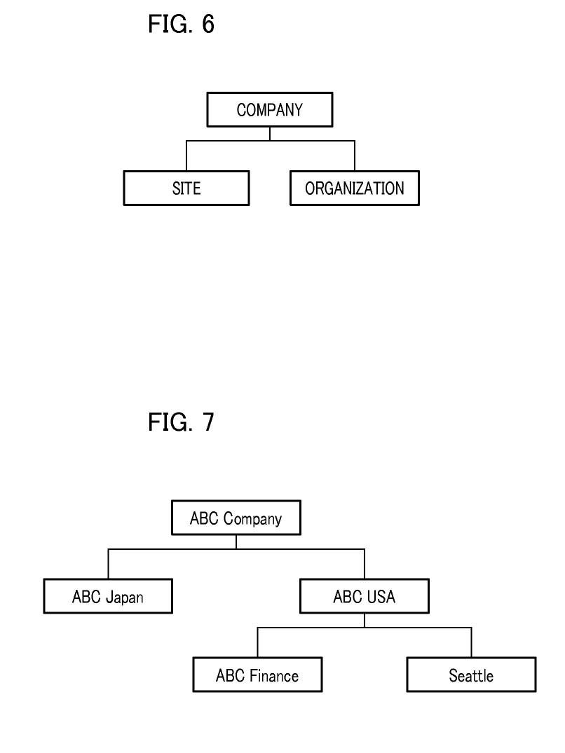

FIG. 6 illustrates an example of the hierarchical structure of tenant type displayed by the tenant type information illustrated in FIG. 5A. In the present embodiment, the tenant type will be described with reference to an example of an organization and a site in a subordinate hierarchical level of a company. In the present embodiment, although there is only a single tenant type hierarchical level, a plurality of hierarchical levels may be provided.

### Tenant Information Table

FIG. 5B is a tenant information table that illustrates an example of the configuration of tenant information that is managed by the tenant information managing unit 402. Also, the table manages information, indicating a hierarchical relationship between tenants, as tenant information.

The tenant information table illustrated in FIG. 5B is configured from a tenant ID 511, a tenant name 512, a tenant type ID 513, and a superordinate tenant ID 514. The column for the tenant ID 511 indicates the ID that uniquely identifies the tenant in the system. The column for the tenant name 512 indicates the name of the tenant. The column for the tenant type ID 513 indicates the tenant type of a given tenant. The column for the superordinate tenant ID 514 indicates the ID of the tenant in the superordinate level. The respective setting values for the tenant information table may be set or changed from the input apparatus of the managing server 103. Alternatively, a tenant information table may be created for each tenant.

### Tenant Access Right Information Table

FIG. 5C is a tenant access right information table that illustrates an example of the configuration of tenant access right information that is managed by the tenant information managing unit 402. The tenant access right information table illustrated in FIG. 5C is configured from a tenant ID 531 and an access permission 532. The tenant that is indicated by the tenant ID 531 has an access right in relation to the service provider indicated by the access permission 532. The respective setting values for the tenant access right information table may be set or changed from the input apparatus of the managing server 103. Alternatively, a tenant access right information table may be created for each tenant. Furthermore, although the access permission in the present embodiment is managed with reference to the service provider unit, a configuration is possible of management with reference to a user unit, or the like.

FIG. 7 illustrates an example of the hierarchical structure of a tenant displayed with reference to the tenant information illustrated in FIG. 5B. In this context, the tenant is indicated as a company other than in relation to Seattle. Seattle is a tenant that indicates a site of ABC USA. Seattle is one site within ABC USA and is divided as another tenant due to the fact that Seattle is subject to consignment of duties to another service provider by the service provider that manages ABC USA.

### Group Type Information Table

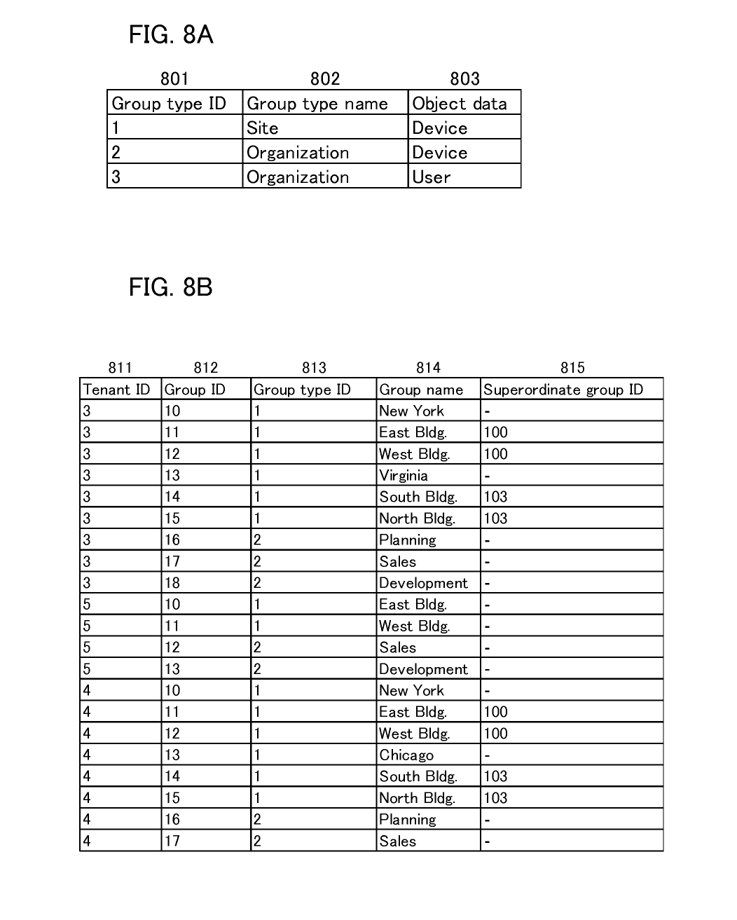

FIG. 8A is a group type information table that illustrates an example of the configuration of group type information that is managed by the group information managing unit 403. The data in the tenant is grouped for management. For example, the information for the device(s) that are managed by the tenant are grouped and managed with reference to a unit such as an organization or site to which the device belongs. The unit of organization or site is the group type.

The group type information table illustrated in FIG. 8A is configured from a group type ID 801, a group type name 802, and object data 803. The column for the group type ID 801 indicates the ID that uniquely identifies the group type in the system. The column for the group type name 802 indicates the group type name. The column for object data 803 is the group object, and indicates data relating to a given group. The respective setting values for the group type information table may be set or changed from the input apparatus of the managing server 103.

### Group Information Table

FIG. 8B is a group information table that indicates an example of the configuration of group information that is managed by the group information managing unit 403. The table also manages information, that indicates a hierarchical relationship between groups, as group information. The group information table illustrated in FIG. 8B is configured from a tenant ID 811, a group ID 812, a group type ID 813, a group name 814, and a superordinate group ID 815. The column for the tenant ID 811 indicates the group of a given tenant. The column for the group ID 812 indicates the ID that uniquely identifies the group in the tenant. The column for the group type ID 813 indicates the group of a given group type. The column for the group name 814 indicates the group name. The column for the superordinate group ID 815 indicates the group ID of the superordinate level. The respective setting values for the group information table may be set or changed from the input apparatus of the managing server 103. Alternatively, a group information table may be created for each tenant.

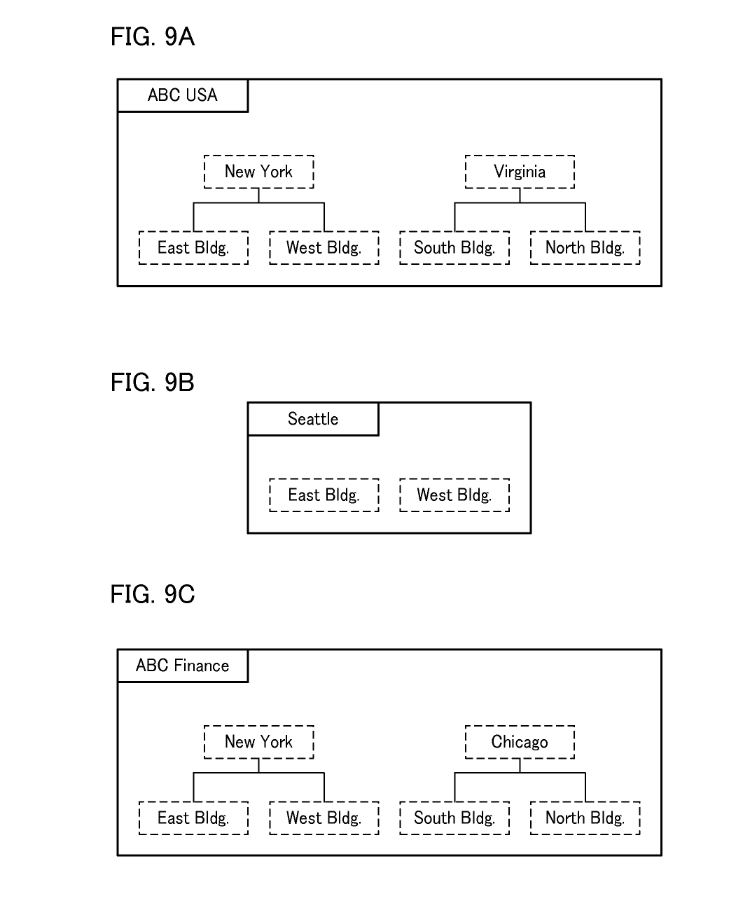

FIGS. 9A to 100 illustrate an example of the hierarchical structure of a group expressed by the group information illustrated in FIG. 8B. FIG. 9A illustrates the hierarchical structure of the site group in the ABC USA tenant that has a tenant ID of 3. FIG. 9B illustrates the hierarchical structure of the site group in the Seattle tenant that has a tenant ID of 5. Seattle assigned the same positioning as the group in the first hierarchical level denoted as New York or Virginia in ABC USA that is illustrated in FIG. 9A. Therefore, the group in the first hierarchical level of Seattle (East Bldg. and West Bldg.) is assigned the same positioning as the group in the second hierarchical level in ABC USA that is illustrated in FIG. 9A. FIG. 9C illustrates the hierarchical structure of the site group in the ABC Finance tenant.

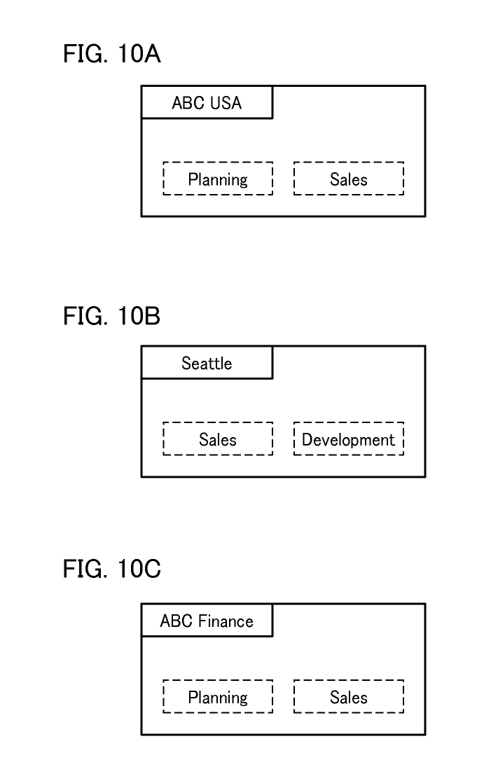

FIG. 10A illustrates the hierarchical structure of the organization group in the ABC USA tenant. FIG. 10B illustrates the hierarchical structure of the organization group in the Seattle tenant. Since Seattle is a company in the same manner as ABC USA, Sales that is the organization of Seattle is the same organization as Sales that is the organization within ABC USA illustrated in FIG. 10A. FIG. 10C illustrates the hierarchical structure of the organization group in the ABC Finance tenant.

### Device Information Table

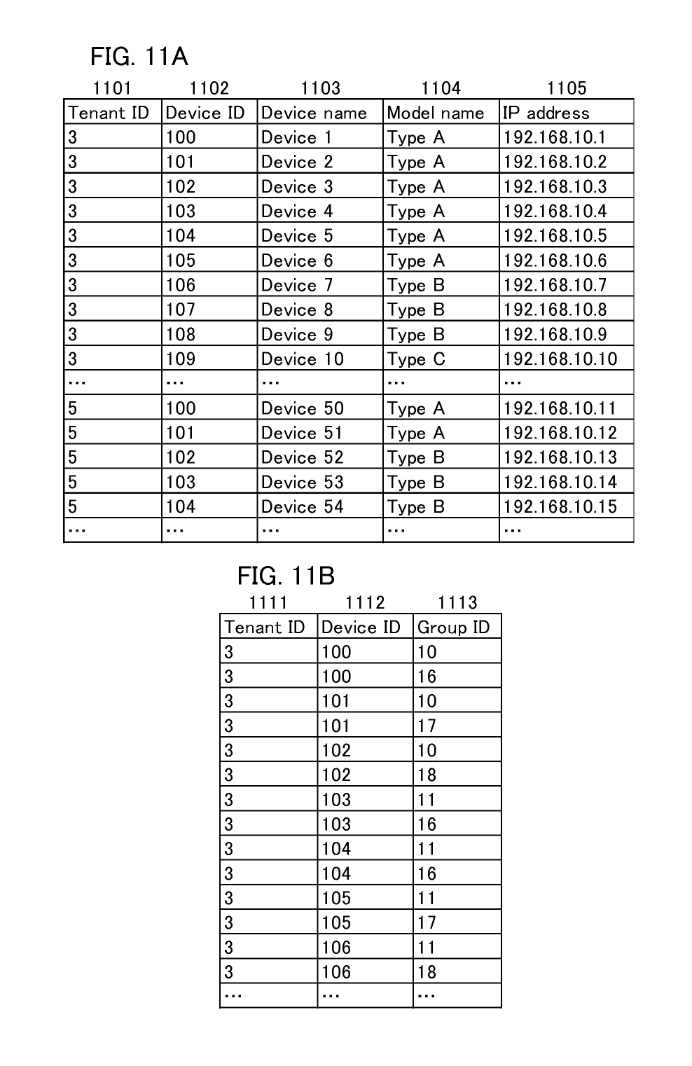

FIG. 11A is a device information table that illustrates an example of the configuration of device information that is managed by the device information managing unit 404 illustrated in FIG. 4. The device information table illustrated in FIG. 11A is configured from a tenant ID 1101, a device ID 1102, a device name 1103, a model name 1104, and an IP address 1105. The column for the tenant ID 1101 indicates the device of a given tenant. The column for the device ID 1102 indicates the ID that uniquely identifies the device in the tenant. The column for the device name 1103 indicates the name of the device and stores the name that is uniquely identified in the device information table. The column for the model name 1104 indicates the name of the model of the device. The column for the IP address 1105 indicates the IP address of the device. The respective setting values for the device information table may be set or changed from the input apparatus of the managing server 103. Alternatively, values can be set that are acquired from the device. Furthermore, a device information table may be created for each tenant.

### Device Group Information Table

FIG. 11B is a device group information table that illustrates an example of the configuration of device group information that is managed by the device information managing unit 404 illustrated in FIG. 4. The device group information table illustrated in FIG. 11B is configured from a tenant ID 1111, a device ID 1112, and a group ID 1113. A device that is indicated by the device ID 1112 for the tenant having a tenant ID of 1111 belongs to the group indicated by the group ID 1113. For example, when the row is considered in which the tenant ID is 3, the device ID is 100 and the group ID is 10, the device having a device ID of 100 belongs to New York of ABC USA. Furthermore, if the device is related to a group that has a different group type, the device may belong to a plurality of groups. The respective setting values for the device group information table may be set or changed from the input apparatus of the managing server 103. Alternatively, a device group information table may be created for each tenant.

### List Information Table

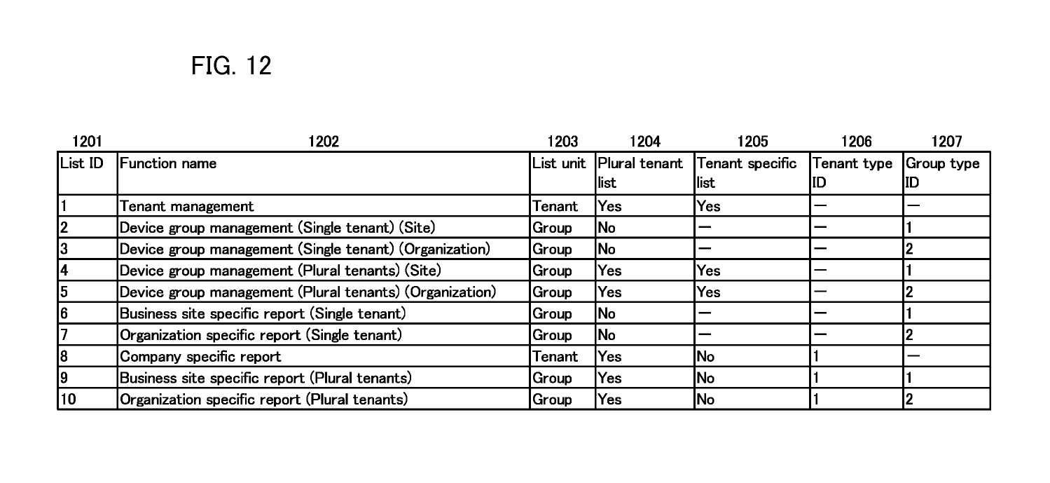

FIG. 12 is a list information table that illustrates an example of the configuration of list information that is managed by the list creating unit 405. List information is information that indicates which form of a list is displayed in relation to respective functions. Furthermore, this table may be used when creating a screen that returns an answer when the host computers 101 and 102 have requested a report or the like.

The information illustrated in FIG. 12 is configured from a list ID 1201, a function name 1202, a list unit 1203, a plural tenant list 1204, a tenant specific list 1205, a tenant type ID 1206, and a group type ID 1207. The column for the list ID 1201 indicates the ID that uniquely identifies the list information in the system. The column for the function name 1202 indicates the name of the function that displays the list. The column for the list unit 1203 indicates whether the list is displayed with reference to a tenant unit or whether the list is displayed with reference to a group unit, and stores either unit.

The column for the plural tenant list 1204 has a setting of No when the list contains a single tenant and a setting of Yes when the list contains a plurality of tenants. The column for the tenant specific list 1205 has a setting of Yes when it is a simple display for each tenant, and a setting of No when that is not the case. This information is set only in relation to a list display of a plurality of tenants (plural tenants list 1204 is Yes). The column for the tenant type ID 1206 indicates the list display of a given tenant type unit when it is not a simple display of each tenant (tenant specific list 1205 is No). The column for the group type ID 1207 indicates the list display of a given group type unit for a group list display (the list unit is group).

### Settable Tenant Type Determination Processing

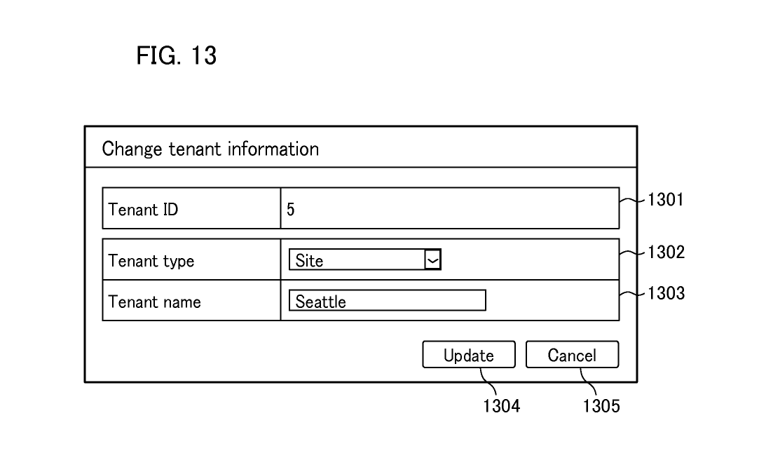

FIG. 13 illustrates an example of a tenant information change screen. The tenant information change screen is a screen configured to change the information related to the tenant that is retained by the tenant information managing unit 402 illustrated in FIG. 4. The tenant type 1302 or tenant name 1303 of the tenant corresponding to the tenant ID 1301 can be changed on the tenant information change screen. When this information is changed by a user and the update button 1304 is pressed, the changes are set in the HTTP request and sent to the managing server 103. The interface unit 401 receives the HTTP request, checks the input information, and if there is not a problem, the managing server 103 sends a tenant information change request to the tenant information managing unit 402. The tenant information managing unit 402 receives the tenant information change request and changes the information for the tenant corresponding to the tenant information managing table.

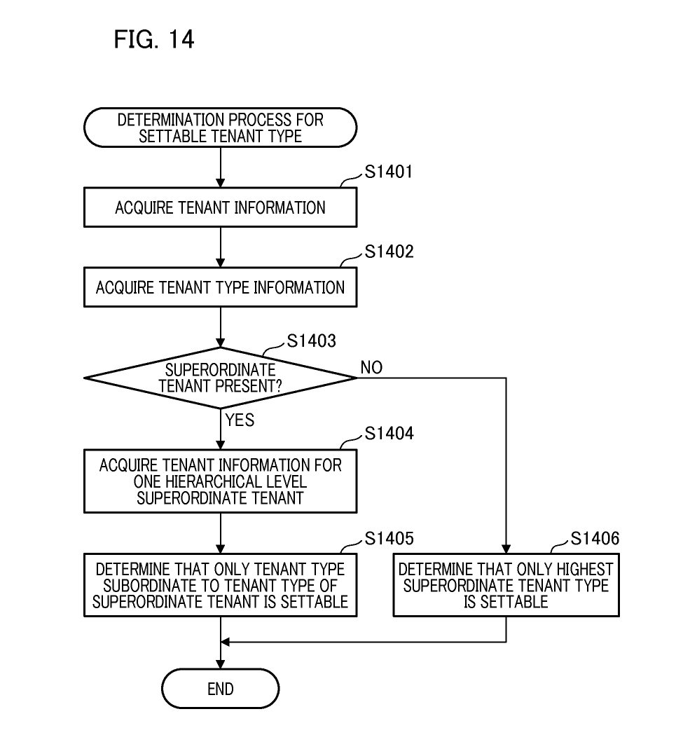

FIG. 14 is a flowchart illustrating an example of the sequence of a settable tenant type determination processing that is executed by the tenant information managing unit 402 illustrated in FIG. 4. The present example is an example of processing by the managing server 103 illustrated in FIG. 1 as an information processing device. The managing server 103 executes the processing when the tenant information change screen illustrated in FIG. 13 is displayed. The processing enables setting of the tenant type determined to be selectable as a selectable option for the tenant type 1302 on the tenant information change screen illustrated in FIG. 13. Steps S1401 to S1406 illustrate respective steps, and each step is performed by execution by the CPU 201 of a control program loaded onto the RAM 203 from the HD 211, the ROM 202, or the like.

When the settable tenant type determination process starts, in S1401, the tenant information managing unit 402 acquires information for the tenant that is the object of the information change from the tenant information retained in the tenant information table (FIG. 5B). Next, in S1402, the tenant information managing unit 402 acquires the tenant type information that is retained in the tenant type information table. Then, in S1403, the tenant information managing unit 402 uses the superordinate tenant ID 514 in the tenant information acquired in S1401 to determine whether or not a superordinate tenant is present (whether there is a superordinate tenant ID 514). When the tenant information managing unit 402 determines that a superordinate tenant is present, the processing proceeds to S1404. On the other hand, when the tenant information managing unit 402 determines that a superordinate tenant is not present, the processing proceeds to S1406. In S1404, the tenant information managing unit 402 uses the superordinate tenant ID 514 in the tenant information acquired in S1401 to acquire the one hierarchical level superordinate tenant information from the tenant information retained in the tenant information table.

Then in S1405, the tenant information managing unit 402 acquires, from the tenant type information table, the tenant type that is subordinate to the tenant type in the superordinate tenant information acquired in S1404. When it is determined that the acquired subordinate tenant type is a settable tenant type, and the processing is completed. On the other hand, in S1406, the tenant information managing unit 402 acquires the highest superordinate tenant type (no superordinate tenant type ID 503) from the tenant type information. When it is determined that the acquired highest superordinate tenant type is a settable tenant type, and the processing is completed.

### Type Change Determination Processing for Subordinate Tenant

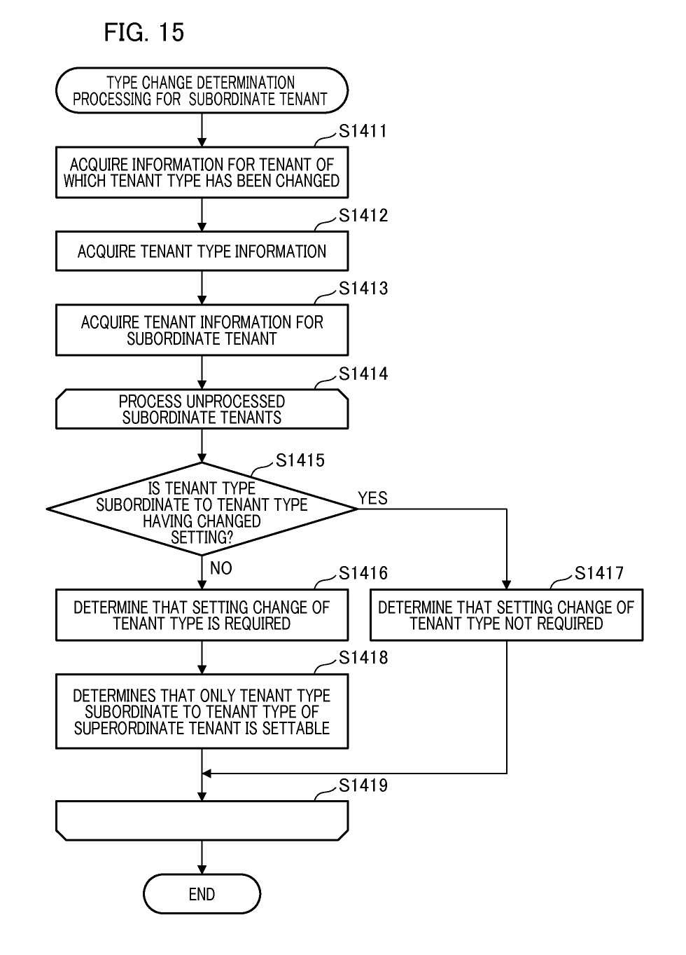

FIG. 15 is a flowchart illustrating an example of the sequence of type change determination processing for a subordinate tenant that is executed by the tenant information managing unit 402 illustrated in FIG. 4. The present example is an example of processing by the managing server 103 illustrated in FIG. 1 as an information processing device. The managing server 103 executes the processing when the tenant type 1302 is updated by use of the tenant information change screen illustrated in FIG. 13. The processing determines whether or not it is necessary to change a tenant type of a subordinate tenant in relation to a tenant of which the tenant type is updated. The tenant information change screen is guided for a setting change in relation to the subordinate tenant that is determined to require a change of tenant type. In addition, a method may be proposed in which a forcible setting change or the like is made in relation to a tenant type that has been determined to be settable. Respective steps are shown in S1411 to S1419, and each step is performed by execution by the CPU 201 of a control program loaded onto the RAM 203 from the HD 211, the ROM 202, or the like.

When the type change determination process for the subordinate tenant is started, in S1411, the tenant information managing unit 402 acquires information for the tenant of which the tenant type has been changed from the tenant information retained in the tenant information table. Next, in S1412, the tenant information managing unit 402 acquires the tenant type information that is retained in the tenant type information table. Then, in S1413, the tenant information managing unit 402 searches for a tenant that is subordinate to the tenant acquired in S1401 by use of the tenant information retained in the tenant information table, to thereby acquire the information. The tenant information managing unit 402 repeats the processing in the flow from S1414 to S1419 for each respective tenant in relation to the unprocessed subordinate tenants out of the subordinate tenants acquired in S1413.

In S1415, the tenant information managing unit 402 determines whether or not the tenant type of the subordinate tenant being processed is a subordinate tenant type relative to the tenant type of the tenant of which the tenant type has been changed. In this context, when the tenant information managing unit 402 determines that the tenant type is not subordinate, the processing proceeds to S1416. On the other hand, when the tenant information managing unit 402 determines that the tenant type is subordinate, the processing proceeds to S1417. For example, it is assumed that the tenant type of Seattle is changed from a company (tenant type ID 1) to a site (tenant type ID 2). Thus, since the type of subordinate tenant to Seattle is site (tenant type ID 2) or organization (tenant type ID 3), this does not result in a subordinate tenant type ID of Seattle. Therefore, in the processing in S1416, the tenant information managing unit 402 determines that a setting change of the tenant type is required in relation to the subordinate tenant being processed.

In S1418, the tenant information managing unit 402 acquires the tenant type that is subordinate to the tenant type of the tenant of which the tenant type has been changed from the tenant type information table. The acquired subordinate tenant type is determined to be a settable tenant type in relation to the subordinate tenant being processed. On the other hand, in S1417, the tenant information managing unit 402 determines that a setting change of the tenant type is not required in relation to the subordinate tenant being processed.

In S1419, the tenant information managing unit 402 determines whether or not there is a subordinate tenant that has not been subjected to the processing in S1414 to S1419. In this context, when the tenant information managing unit 402 determines that there is a subordinate tenant that has not been subjected to the processing in S1414 to S1419, the processing returns to S1414 and the process is repeated. On the other hand, when the tenant information managing unit 402 determines that there is not a subordinate tenant that has not been subjected to the processing in S1414 to S1419, the processing is completed.

### List Creation Processing

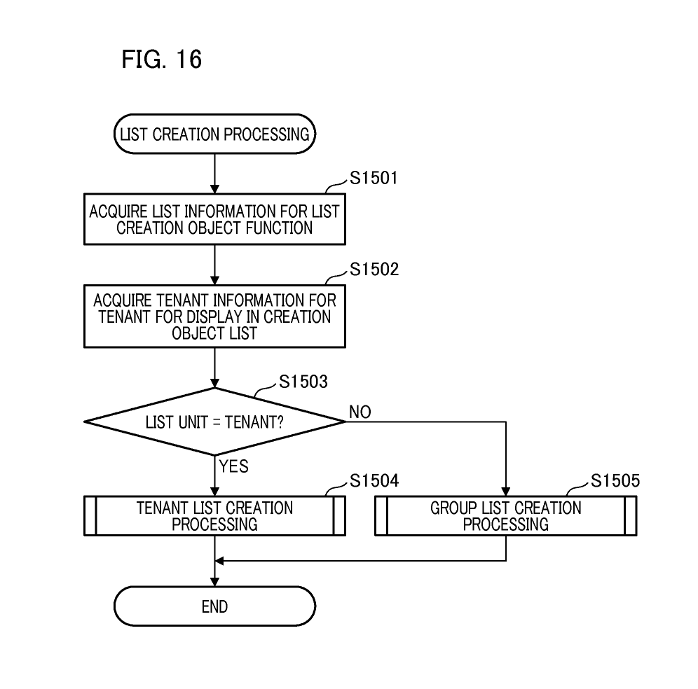

FIG. 16 is a flowchart illustrating an example of the sequence of a list creation processing that is executed by the list creating unit 405 illustrated in FIG. 4. The present example is an example of processing by the managing server 103 illustrated in FIG. 1 as an information processing device. The managing server 103 uses the list information illustrated in FIG. 12 to create a suitable tenant or group list for each function. The list created by the present processing is outputted to a report or screen or the like for each function. Respective steps are shown in S1501 to S1505, and each step is performed by execution by the CPU 201 of a control program loaded onto the RAM 203 from the HD 211, the ROM 202, or the like.

When the list creation processing starts, in S1501, the list creating unit 405 uses the list information retained in the list information table illustrated in FIG. 12 to acquire list information corresponding to the function of the list creation object. Then in S1502, the list creating unit 405 uses the tenant information (FIG. 5B) retained in the tenant information table to acquire all the information for the tenant to be displayed on the list being created.

Then in S1503, the list creating unit 405 determines whether or not the list unit information 1203 for the list information acquired in S1503 is a tenant. That is to say, it is determined whether the list being created is a tenant list or a group list. In this context, when the list creating unit 405 determines that the list unit information 1203 is a tenant, the processing proceeds to S1504. For example, when the list ID in FIG. 12 is 1 or 8, since the list unit information 1203 relates to a tenant, the processing proceeds to S1504. On the other hand, when the list creating unit 405 determines that the list unit information 1203 is not a tenant, the processing proceeds to S1505. For example, when the list ID in FIG. 12 is 4 or 9, since the list unit information 1203 relates to a group, the processing proceeds to S1505. Next, in S1504, the list creating unit 405 performs tenant list creation processing and the processing is completed. The details of the tenant list creation processing will be described below. On the other hand, in S1505, the list creating unit 405 performs group list creation processing, and the processing is completed. The details of the group list creation processing will be described below.

### Tenant List Creation Processing

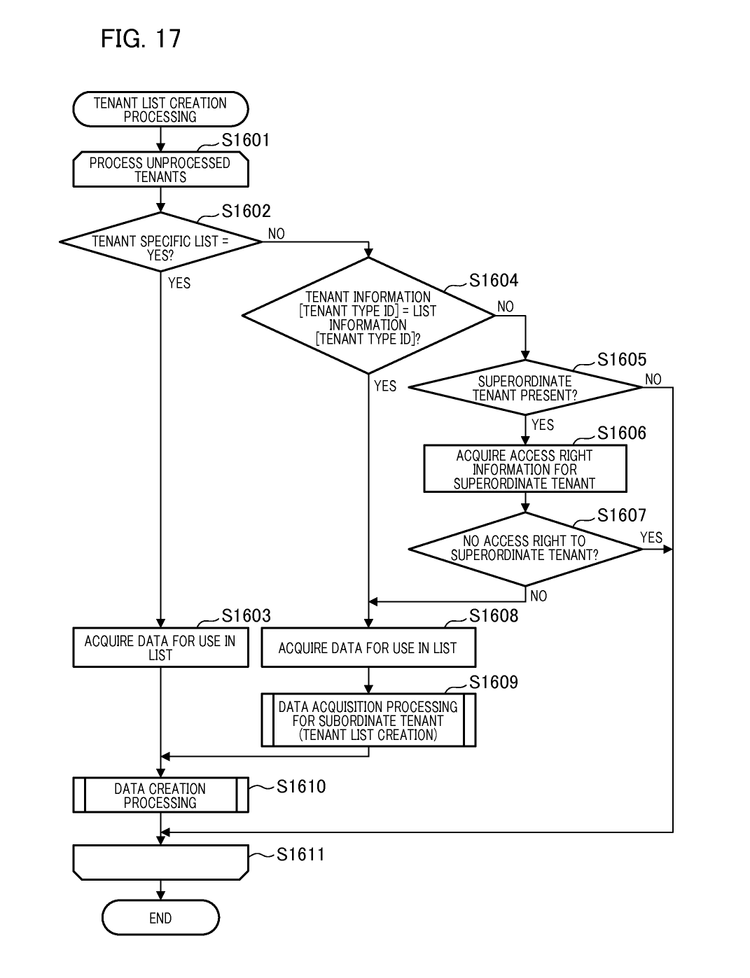

FIG. 17 is a flowchart illustrating an example of the detailed sequence of a tenant list creation processing that is executed in S1504 illustrated in FIG. 16. For example, when the processing object has a list ID of 1 or 8 in FIG. 12, the managing server 103 provides a tenant managing function or a company specific report function according to the flowchart. This processing enables creation of a suitable tenant list for each function. Respective steps are shown in S1601 to S1611, and each step is performed by execution by the CPU 201 of a control program loaded onto the RAM 203 from the HD 211, the ROM 202, or the like.

When tenant list creation processing is started, the list creating unit 405 repeats the processing in the flow from S1601 to S1611 for each respective tenant in relation to the unprocessed tenants of those tenants acquired in S1502. Then, in S1602, the list creating unit 405 determines whether or not the tenant specific list 1205 in the list information acquired in S1501 has a value of Yes. That is to say, it is determined whether or not the tenant list being created is a simple list specific a tenant.

In this context, when the list ID 1201 is 1, the list creating unit 405 determines that the tenant specific list 1205 is Yes, and the processing proceeds to S1603. On the other hand, when the list ID 1201 is 8, the list creating unit 405 determines that the tenant specific list 1205 is not Yes, and the processing proceeds to S1604.

In S1603, the list creating unit 405 acquires data in relation to tenants being processed for use in the tenant list being created with reference to data retained by the managing server 103. Then, in S1604, the list creating unit 405 determines whether or not the tenant type ID 513 of the tenant being processed matches the tenant type ID 1206 of the list information acquired in S1501. That is to say, it is determined whether or not the tenant is a tenant type displayed in the list. In row 8 of the tenant ID, since the tenant type ID is 1, when the ID 513 is 1, the list creating unit 405 determines that the two tenant type IDs match, and the processing proceeds to S1608. On the other hand, when the list creating unit 405 determines that the two tenant type IDs do not match, and the processing proceeds to S1605.

Next, in S1605, the list creating unit 405 uses the superordinate tenant ID 514 of the tenant being processed to determine whether or not a superordinate tenant is present (whether there is a superordinate tenant ID 514). For example, when the tenant being processed is Seattle, the list creating unit 405 determines that a superordinate tenant is present, and the processing proceeds to S1606. On the other hand, when the list creating unit 405 determines that a superordinate tenant is not present, and the processing proceeds to S1611. In S1606, the list creating unit 405 uses the superordinate tenant ID 514 of the tenant being processed to acquire access right information for the one hierarchical level superordinate tenant from the tenant access right information retained in the tenant access right information table. For example, when the tenant being processed is Seattle, the superordinate tenant ID is 3, and therefore, the list creating unit 405 acquires Service Provider USA as the access right information.

Then in S1607, the list creating unit 405 uses the access right information of the superordinate tenant acquired in S1606 to determine whether or not there is an access right to the superordinate tenant for a user who has executed the function of the list creation object. That is to say, even when a tenant being processed is not a tenant of a tenant type that is displayed in the list, but rather is the highest superordinate tenant in the accessible range of the user who has executed the function of the list creation object, it is determined to display the tenant in the list. This feature represents processing for the purpose of preventing data for the tenant being processed from not being included in the list.

For example, in the case of Seattle, since Service Provider USA is stored in the access right information table, when the list creating unit 405 determines that there is an access right to a superordinate tenant, the processing proceeds to S1611. On the other hand, when the list creating unit 405 determines that there is not an access right to a superordinate tenant, the processing proceeds to S1608.

In S1608, the list creating unit 405 acquires data related to the tenant being processed for use in the tenant list being created with reference to data retained by the managing server 103. Then in S1609, the list creating unit 405 performs data acquisition processing for the subordinate tenant. The detailed description of data acquisition processing for the subordinate tenant will be given below. Then in S1610, the list creating unit 405 performs data creation processing. The detailed description of the data creation processing will be given below. Next, in S1611, the list creating unit 405 determines whether or not there is a tenant that has not been subjected to the processing in S1601 to S1611. In this context, when the list creating unit 405 determines that there is a tenant that has not been subjected to the processing in S1601 to S1611, the processing returns to S1601 and the process is repeated. On the other hand, when the list creating unit 405 determines that there is not a tenant that has not been subjected to the processing in S1601 to S1611, the processing is completed.

### Data Acquisition Processing for Subordinate Tenant (Tenant List Creation

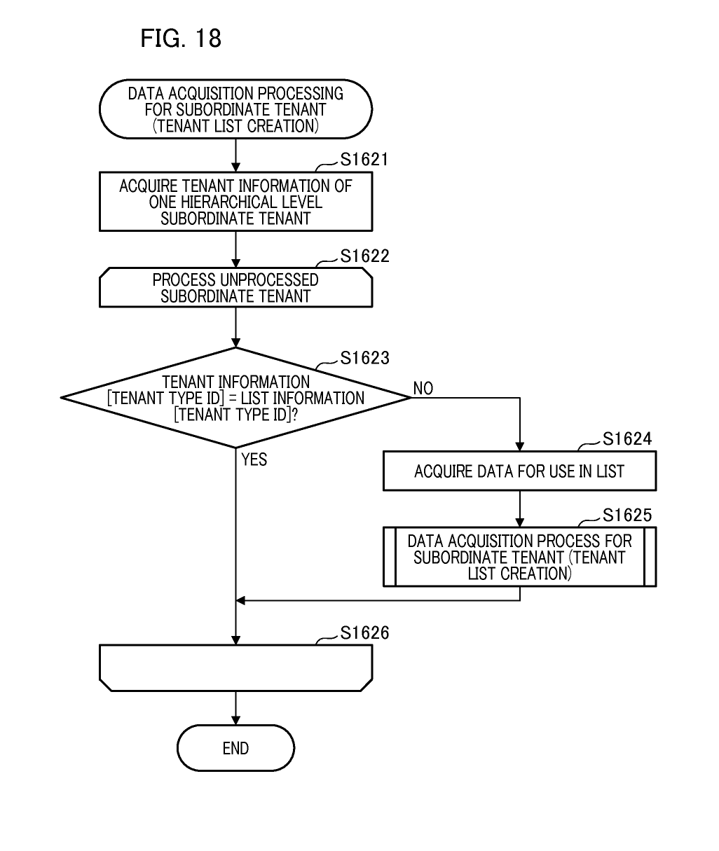

FIG. 18 is a flowchart illustrating an example of the detailed sequence of a data acquisition processing for a subordinate tenant that is executed in S1609 illustrated in FIG. 17. The flowchart above is applied when providing a company specific report function. The processing acquires data for a subordinate tenant that is handled as data for the tenant being processed. Respective steps are shown in S1621 to S1626, and each step is performed by execution by the CPU 201 of a control program loaded onto the RAM 203 from the HD 211, the ROM 202, or the like.

When data acquisition processing for the subordinate tenant starts, in S1621, the list creating unit 405 searches for a tenant that is one hierarchical level subordinate to the tenant being processed by use of the tenant information retained in the tenant information table, and thereby acquires information. The list creating unit 405 repeats the processing in the flow from S1622 to S1626 for each respective tenant in relation to the unprocessed subordinate tenants of those subordinate tenants acquired in S1621.

Next, in S1623, the list creating unit 405 determines whether or not the tenant type ID 513 of the subordinate tenant being processed matches the tenant type ID 1206 of the list information acquired in S1501. That is to say, it is determined whether or not the tenant is a tenant type displayed in the list in relation to the subordinate tenant being processed. The determination is for the purpose of handling the data of the subordinate tenant being processed as data for a superordinate tenant when it is determined that the tenant is a tenant type that is not displayed in the list.

When the list creating unit 405 determines that the two tenant type IDs match, and the processing proceeds to S1626. On the other hand, when the list creating unit 405 determines that the two tenant type IDs do not match, and the processing proceeds to S1624. Next, in S1624, the list creating unit 405 acquires data in relation to the subordinate tenant being processed that is used in the tenant list being created in relation to the data retained in the managing server 103. Then, in S1625, the list creating unit 405 performs data acquisition processing in relation to the subordinate tenant for the subordinate tenant being processed. The list creating unit 405 adds the data of the acquired subordinate tenant to the data of the superordinate tenant. Then, in the next step S1626, the list creating unit 405 determines whether or not there is a subordinate tenant that has not been subjected to the processing in S1622 to S1626. In this context, when the list creating unit 405 determines that there is a subordinate tenant that has not been subjected to the processing in S1622 to S1626, the processing returns to S1622 and the process is repeated. On the other hand, when the list creating unit 405 determines that there is not a subordinate tenant that has not been subjected to the processing in S1622 to S1626, the processing is completed.

### Data Creation processing

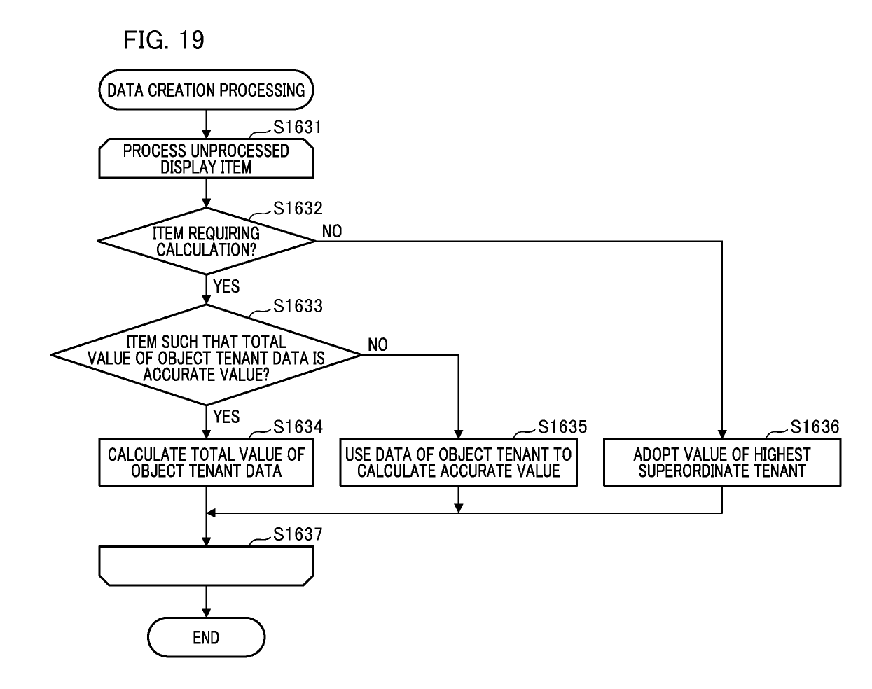

FIG. 19 is a flowchart illustrating an example of the detailed sequence of data creation processing that is executed in S1610 illustrated in FIG. 17. The data that has been acquired in steps S1603, or S1608 and S1609 is used to create data that is displayed in a list of the tenant being processed. The data displayed in a list of the tenant being processed also includes data for a subordinate tenant that is handled as data for the tenant being processed acquired in S1609. This processing indicates how the data for a subordinate tenant is included. Respective steps are shown in S1631 to S1637, and each step is performed by execution by the CPU 201 of a control program loaded onto the RAM 203 from the HD 211, the ROM 202, or the like.

When the data creation processing starts, the list creating unit 405 repeats the processing for each respective display item in relation to the unprocessed display items in the flow from S1631 to S1637 of those display items displayed in the list being created. Then in S1632, the list creating unit 405 determines whether or not an item being processed is an item that requires calculation. An item that requires calculation is an item that must be a total value of data for each object tenant (tenant being processed and subordinate tenant), or an item that requires recalculation using data for each object tenant, and does not refer to character string data such as a name. When the list creating unit 405 determines that an item is an item that requires calculation, the processing proceeds to S1633. On the other hand, when the list creating unit 405 determines that an item is not an item that requires calculation, the processing proceeds to S1636.

Next in S1633, the list creating unit 405 determines whether or not an item being processed is an item in which the total value of data for each object tenant takes an accurate value. An item in which the total value takes an accurate value for example denotes an item in which it is sufficient if the total value for each object tenant, such as a managed device number, or the like, is displayed. On the other hand, an item in which the total value does not take an accurate value is an item that requires recalculation by use of data for each object tenant, such as a ratio value, or the like. In this context, when the list creating unit 405 determines that the item is an item in which the total value takes an accurate value, the processing proceeds to S1634. On the other hand, when the list creating unit 405 determines that the item is not an item in which the total value takes an accurate value, the processing proceeds to S1635. Next in S1634, the list creating unit 405 calculates a total value of data for each object tenant and configures the result as display data for the item being processed.

On the other hand, in S1635, the list creating unit 405 calculates an accurate value by use of data for each object tenant and configures the result as display data for the item being processed. In S1636, the list creating unit 405 configures the value for the highest superordinate tenant being processed as display data for an item being processed. In S1637, the list creating unit 405 determines whether or not there is a display item that has not been processed in S1631 to S1637. In this context, when the list creating unit 405 determines that there is a display item that has not been processed in S1631 to S1637, the processing returns to S1631 and the process is repeated. Conversely, when the list creating unit 405 determines that there is not a display item that has not been processed in S1631 to S1637, the processing is completed.

### Tenant List Display Example

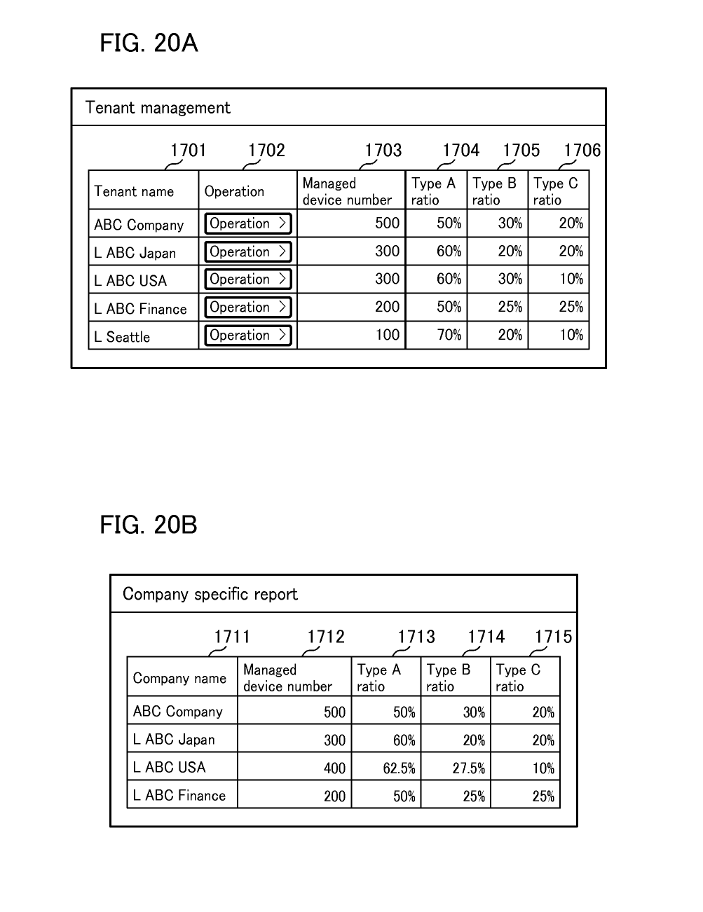

FIGS. 20A and 20B illustrate an example of a tenant list display created by a tenant list creation processing as illustrated in FIG. 16 to FIG. 19. FIG. 20A illustrates an example of a tenant list display of a tenant managing function for the list ID taking a value of 1 in the list information table illustrated in FIG. 12. This function envisages use by a service provider for managing of each tenant. The service provider selects and operates a tenant by the function.

The tenant managing screen example illustrated in FIG. 20A is configured by the tenant name 1701 to the Type C ratio 1706. The column of the tenant name 1701 in FIG. 20A displays the name for each tenant. The column for the operation 1702 displays an operation button that transitions to a function of operating the tenant. The column for the managed device number 1703 displays the managed device number in a tenant. The column for Type A ratio 1704 displays the ratio of the device number in which a model is Type A relative to the managed device number in a tenant. The column for Type B ratio 1705 displays the ratio of the device number in which a model is Type B relative to the managed device number in a tenant. The column for Type C ratio 1706 displays the ratio of the device number in which a model is Type C relative to the managed device number in a tenant.

The tenant type of ABC USA is company, the tenant type of Seattle is site (one site of the ABC USA company), and therefore the tenant type is different. As a result, in the present function, ABC USA and Seattle are distinguished when displayed. This is due to the fact that a service provider must manage by tenant unit. That is to say, in the present function, the list display is adapted by tenant unit.

FIG. 20B illustrates a tenant list display example of a company specific report function having a list ID taking a value of 8 in the list information table illustrated in FIG. 12. The present function envisages use for perusal of information related to each company by a customer. The example of the company specific report function illustrated in FIG. 20B is configured from a company name 1711 to the Type C ratio 1715. The column of the company name 1711 in FIG. 20B displays the name of each tenant as a company name. The column for the managed device number 1712 displays the managed device number in a company. The column for Type A ratio 1713 displays the ratio of the device number in which a model is Type A relative to the managed device number in a company. The column for Type B ratio 1714 displays the ratio of the device number in which a model is Type B relative to the managed device number in a company. The column for Type C ratio 1715 displays the ratio of the device number in which a model is Type C relative to the managed device number in a company.

The tenant type of ABC USA is company, the tenant type of Seattle is site (one site of the ABC USA company), and therefore the tenant type is different. However, in the present function, the information for Seattle is displayed as ABC USA information. For example, the managed device number 1712 of ABC USA is the total of the managed device number of the ABC USA tenant and the managed device number of the Seattle tenant. The ratio 1713 to 1715 of each model is a value that is recalculated by use of the device number of each model in the ABC USA tenant and the device number of each model in the Seattle tenant. This is due to the fact that Seattle is treated as a tenant for the benefit of the service provider, and must not be distinguished in the display in relation to a function that is used by a customer to peruse information for each company. That is to say, the present function is not adapted by tenant unit but rather is adapted for list display of a company unit.

### Group List Creation Processing

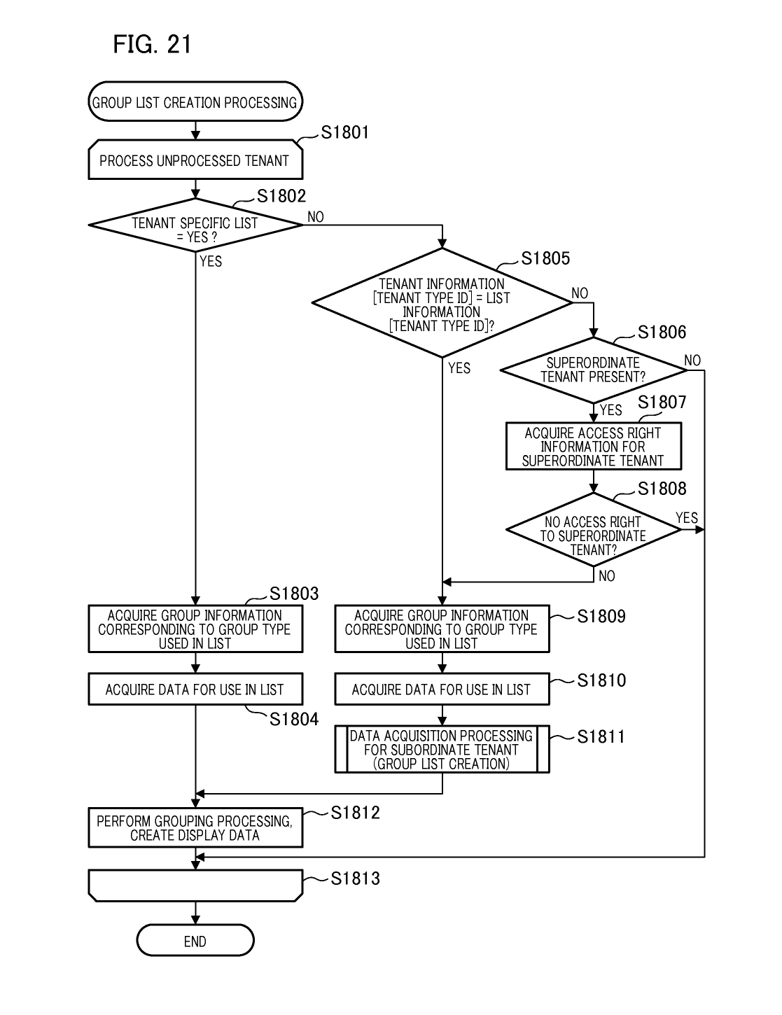

FIG. 21 is a flowchart illustrating an example of the detailed sequence of group list creation processing that is executed in S1505 illustrated in FIG. 16. The processing creates a suitable group list for each function. Respective steps are shown in S1801 to S1813, and each step is performed by execution by the CPU 201 of a control program loaded onto the RAM 203 from the HD 211, the ROM 202, or the like.

When group list creation processing starts, the list creating unit 405 repeats the processing in the flow from S1801 to S1813 for each respective tenant in relation to the unprocessed tenants of those tenants acquired in S1502. Then in S1802, the list creating unit 405 determines whether or not the tenant specific list 1205 for the list information acquired in S1501 has a value of Yes. That is to say, it is determined whether or not the tenant list being created is a simple list for each tenant. For example, when the list ID in FIG. 12 is 4 or 5, the list creating unit 405 determines that the tenant specific list 1205 is Yes, and the processing proceeds to S1803. On the other hand, when the list ID in FIG. 12 is 9 or 10, the list creating unit 405 determines that the tenant specific list 1205 is not Yes, and the processing proceeds to S1805.

In S1803, the list creating unit 405 acquires information for a group that matches the group type ID 1207 of the list information acquired in S1501 from the group information retained in the group information table. Next in S1804, the list creating unit 405 acquires data in relation to the tenant being processed for use in the group list being created from the data retained in the managing server 103.

On the other hand, in S1805, the list creating unit 405 determines whether or not the tenant type ID 1206 of the list information acquired in S1501 matches the tenant type ID 513 of the tenant being processed. That is to say, it is determined whether or not the tenant is a tenant type displayed on the list. In this context, when the list creating unit 405 determines that the two tenant type IDs match, the processing proceeds to S1809. Conversely, when the list creating unit 405 determines that the two tenant type IDs do not match, the processing proceeds to S1806.

In S1806, the list creating unit 405 uses the superordinate tenant ID 514 of the tenant being processed to determine whether or not there is a superordinate tenant (whether there is a superordinate tenant ID 514). In this context, when the list creating unit 405 determines that there is a superordinate tenant, the processing proceeds to S1807. On the other hand, when the list creating unit 405 determines that there is not a superordinate tenant, the processing proceeds to S1813.

In S1807, the list creating unit 405 uses the superordinate tenant ID 514 of the tenant being processed to acquire access right information for the one hierarchical level superordinate tenant from the tenant access right information retained in the tenant access right information table.

Next, in S1808, the list creating unit 405 uses the access right information of the superordinate tenant acquired in S1807 to determine whether or not a user, that has executed the function for the list creation object, has an access right to the superordinate tenant. That is to say, when the tenant being processed is the highest superordinate tenant within the accessible range of a user, that has executed the function for the list creation object, and is not a tenant of a tenant type that is displayed on the list, it is determined to display the tenant being processed on the list. This process is for the purpose of preventing data for the tenant being processed from not being included on the list. In this context, when the list creating unit 405 determines that there is an access right to the superordinate tenant, the processing proceeds to S1813. On the other hand, when the list creating unit 405 determines that there is not an access right to the superordinate tenant, the processing proceeds to S1809.

In S1809, the list creating unit 405 acquires group information in relation to the tenant being processed that matches the group type ID 1207 of the list information acquired in S1501 from the group information retained in the group information table. Then in S1810, the list creating unit 405 acquires data in relation to the tenant being processed for use in the group list to be created in relation to the data retained in the managing server 103. In S1811, the list creating unit 405 performs data acquisition processing of the subordinate tenants. The details of data acquisition processing of the subordinate tenants will be described below.

Next, in S1812, the list creating unit 405 uses the data acquired in S1803 and S1804, or S1809 to S1811 to perform data grouping processing and thereby create data for display in the group list of the tenant being processed. The data displayed in the group list of the tenant being processed also includes data for a subordinate tenant that are handled as data for the tenant being processed acquired in S1811. That is to say, grouping processing is performed by handling data for a subordinate tenant in the same manner as data for the tenant being processed.

Then, in S1813, the list creating unit 405 determines whether or not there is a tenant that has not been subjected to the processing in S1801 to S1813. In this context, when the list creating unit 405 determines that there is a tenant that has not been subjected to the processing in S1801 to S1813, the processing returns to S1801 and the process is repeated. On the other hand, when the list creating unit 405 determines that there is not a tenant that has not been subjected to the processing in S1801 to S1813, the processing is completed.

### Data Acquisition Processing for Subordinate Tenant (Group List Creation)

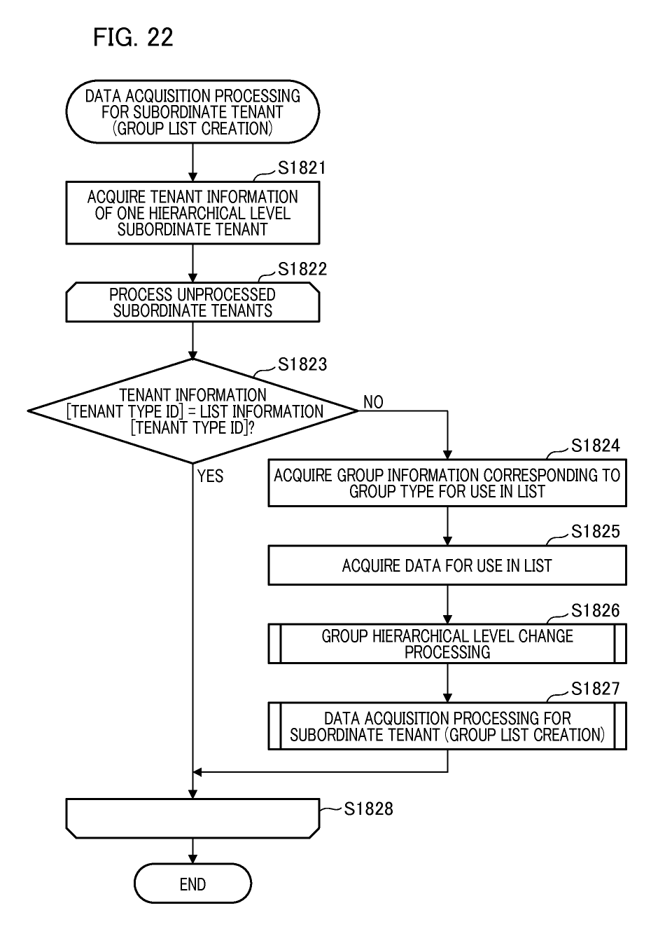

FIG. 22 is a flowchart illustrating an example of the detailed sequence of the data acquisition processing for a subordinate tenant that is executed in S1811 illustrated in FIG. 21. The flowchart is applied when a site specific report function or organization specific report function is provided. The processing acquires data for a subordinate tenant that is handled as data for the tenant being processed. Furthermore, group hierarchical level change processing is performed in relation to a subordinate tenant that is determined to be handled as data for the tenant being processed. The details of the group hierarchical level change processing are given below. Respective steps are shown in S1821 to S1828, and each step is performed by execution by the CPU 201 of a control program loaded onto the RAM 203 from the HD 211, the ROM 202, or the like.

When data acquisition processing for a subordinate tenant starts, in S1821, the list creating unit 405 searches for a tenant in one hierarchical level subordinate to the tenant being processed by use of the tenant information retained in the tenant information table to thereby acquire information. The list creating unit 405 repeats the processing in the flow from S1822 to S1828 for each respective tenant in relation to the unprocessed subordinate tenants of those subordinate tenants acquired in S1821.

Then, in S1823, the list creating unit 405 determines whether the tenant type ID 513 of the subordinate tenant being processed matches the tenant type ID 1206 of the list information acquired in S1501. That is to say, it is determined in relation to the subordinate tenant being processed whether or not the tenant is a tenant of tenant type displayed in the list. When the tenant is a tenant of a tenant type that is not displayed in the list, it is determined to handle the data for the subordinate tenant being processed as data for a superordinate tenant. In this context, when the list creating unit 405 determines that the two tenant type IDs match, the processing proceeds to S1828. On the other hand, when the list creating unit 405 determines that the two tenant type IDs do not match, the processing proceeds to S1824.

In S1824, the list creating unit 405 acquires group information in relation to the subordinate tenant being processed that matches the group type ID 1207 of the list information acquired in S1501 from the group information retained in the group information table. Then in S1825, the list creating unit 405 acquires data in relation to the subordinate tenant being processed for use in the group list being created with reference to the data retained in the managing server 103.

Then, in S1826, the list creating unit 405 performs group hierarchical level change processing. The details of group hierarchical level change processing will be described below. In S1827, the list creating unit 405 performs data acquisition processing for a subordinate tenant in relation to subordinate tenant being processed. Next in S1828, the list creating unit 405 determines whether or not there is a subordinate tenant that has not been subjected to the processing in S1822 to S1828. In this context, when the list creating unit 405 determines that there is a subordinate tenant that has not been subjected to the processing in S1822 to S1828, the processing returns to S1822 and the process is repeated. On the other hand, when the list creating unit 405 determines that there is not a subordinate tenant that has not been subjected to the processing in S1822 to S1828, the processing is completed.

### Group Hierarchical Level Change Processing

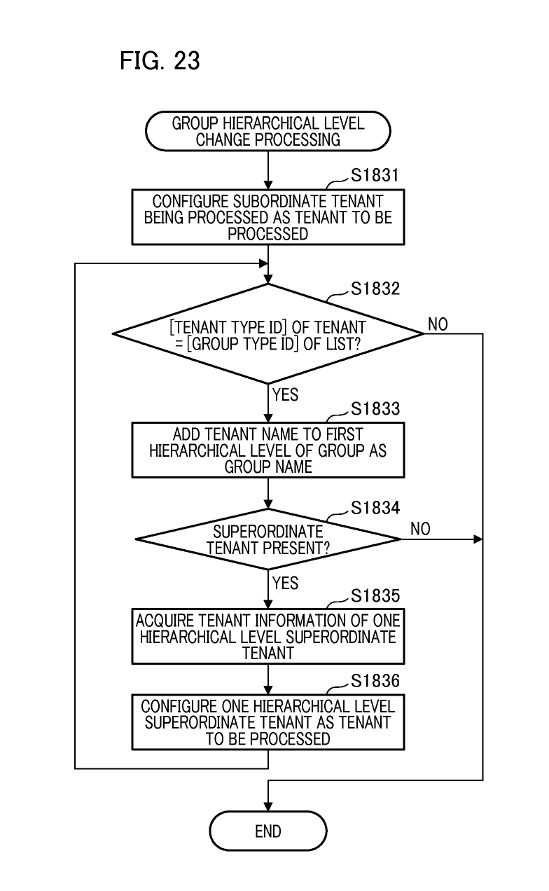

FIG. 23 is a flowchart illustrating an example of the detailed sequence of the group hierarchical level change processing that is executed in S1826 illustrated in FIG. 22. The processing is configured to change the hierarchical level information in the group of the tenant being processed. As illustrated in FIGS. 9A and 9B, Seattle has the same positioning as the first hierarchical level group such as New York or Virginia in ABC USA as illustrated in FIG. 9A. When the list display is perform for site units by company, Seattle is displayed as a first hierarchical level group of ABC USA. In this case, the hierarchical level information is changed by the present processing so that Seattle that is a tenant is configured to be on a first hierarchical level group, and the group which was a first hierarchical level of Seattle is configured to be on a second hierarchical level. Respective steps are shown in S1831 to S1836, and each step is performed by execution by the CPU 201 of a control program loaded onto the RAM 203 from the HD 211, the ROM 202, or the like.

When group hierarchical level change processing starts, in S1831, the list creating unit 405 determines that the subordinate tenant being processed is a tenant being processed in relation to the data acquisition processing for the subordinate tenant as illustrated in FIG. 22. Then in S1832, the list creating unit 405 determines whether or not the tenant type ID 502 corresponding to the tenant type ID 513 of the tenant being processed matches the group type name 802 corresponding to the group type ID 1207 of the list information acquired in S1501. That is to say, it is determined whether or not the tenant type is a group type displayed in the list. For example, since the tenant type ID 2 of Seattle matches the group type ID 1, the list creating unit 405 determines that the two tenant type names match, and the processing proceeds to S1833. On the other hand, when the list creating unit 405 determines that the two tenant type names do not match, and the processing is completed.

In S1833, the list creating unit 405 configures the tenant name of the tenant being processed as the group name, and adds the group name as first hierarchical level for the group information acquired in S1824. In this manner, a first hierarchical level of existing group information becomes a second hierarchical level. The addition processing for the first hierarchical level is a temporary processing operation for the list to be created. As a result, the addition processing result for the first hierarchical level is not retained in the group information table.

Then, in S1834, the list creating unit 405 uses the superordinate tenant ID 514 of the tenant being processed to determine whether or not there is a superordinate tenant (whether there is a superordinate tenant ID 514). In this context, when the list creating unit 405 determines that a superordinate tenant is present, the processing proceeds to S1835. On the other hand, when the list creating unit 405 determines that a superordinate tenant is not present, the processing is completed. Next, in S1835, the list creating unit 405 uses the superordinate tenant ID 514 for the tenant being processed to acquire one hierarchical level superordinate tenant information from the tenant information retained in the tenant information table. Then in S1836, the list creating unit 405 configures the one hierarchical level superordinate tenant acquired in S1836 as the tenant being processed, the processing returns to S1832, and the process is repeated.

### Group List Display Example

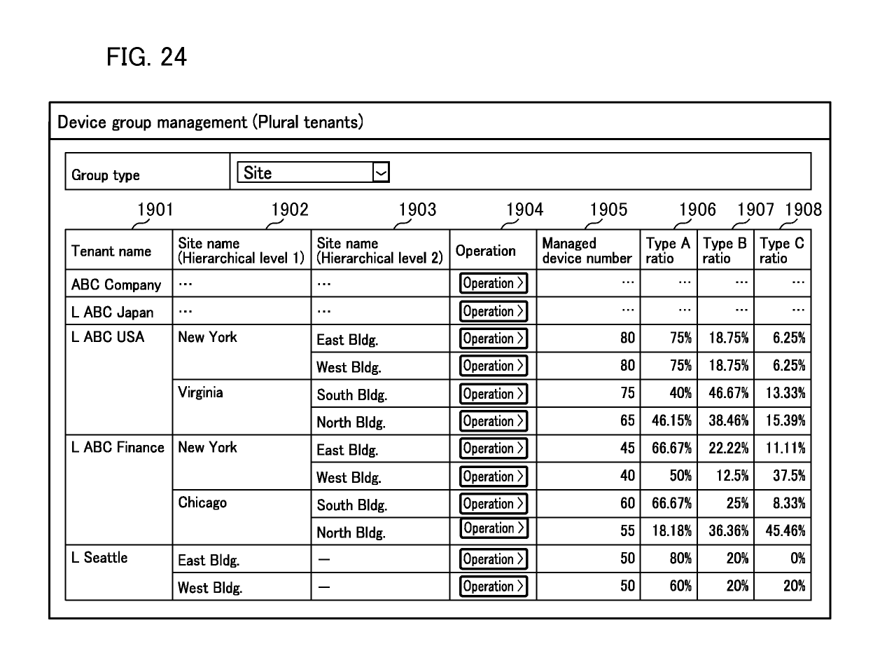

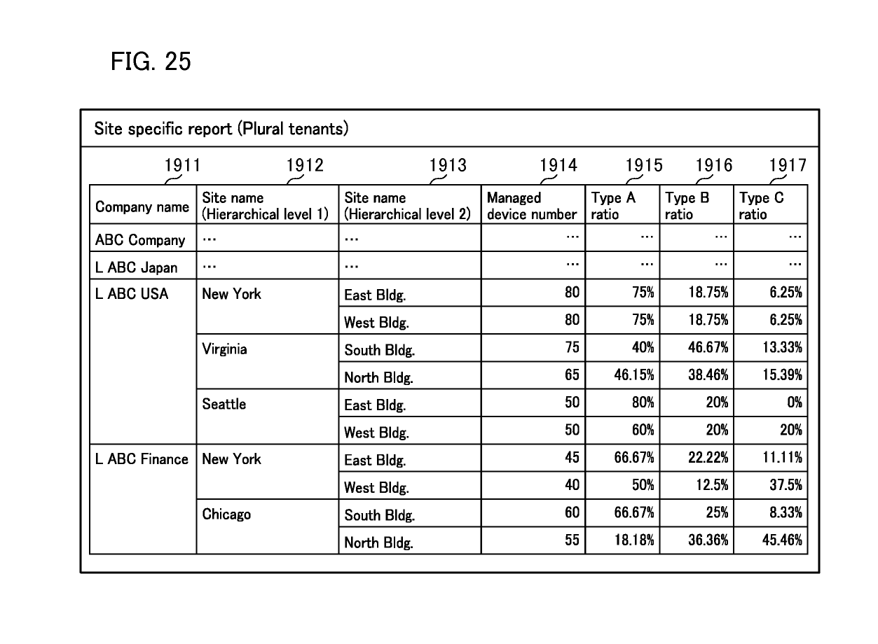

FIGS. 24 and 25 illustrate examples of a group list display created by group list creation processing as illustrated in FIG. 21 to FIG. 23. FIG. 24 illustrates a group list display of the device group (site) managing function for a plurality of tenants having a list ID of 4 in the list information table illustrated in FIG. 12. The present function envisages that the service provider uses the function for managing the group of each tenant. The service provider selects and operates the group by use of the present function.

In FIG. 24, the device group managing list example is configured by a tenant name 1901 to Type C ratio 1908. The column of the tenant name 1901 displays the name of each tenant belonging to one group. The column of the site name 1902 displays a first hierarchical level group name. The column for the site name 1903 displays a second hierarchical level group name as a site name. The column for the operation 1904 displays an operation button that transitions to a function of operating the group. The column for the managed device number 1905 displays the managed device number for each site 1903. The column for Type A ratio 1906 displays the ratio of the device number in which a model is Type A relative to the managed device number for each site name 1903. The column for Type B ratio 1907 displays the ratio of the device number in which a model is Type B relative to the managed device number for each site 1903. The column for Type C ratio 1908 displays the ratio of the device number in which a model is Type C relative to the managed device number for each site 1903.

The tenant type of ABC USA is company, the tenant type of Seattle is site (one site of the ABC USA company), and therefore the tenant type is different. As a result, in the present function, ABC USA and Seattle are distinguished when displayed. This is due to the fact that a service provider must manage by tenant unit. That is to say, in the present function, the list display is adapted to a group unit by tenant.

FIG. 25 illustrates an example of a group list display for a report function by site for a plurality of tenants having a list ID of 9 in the list information table illustrated in FIG. 12. The present function envisages use for the purpose of a customer perusing information by site for each company.

The site report list illustrated in FIG. 25 is configured from a company name 1911 to the Type C ratio 1917. The column of the reference number 1911 displays the tenant name as a company name. The column for the site name 1912 displays the first hierarchical level group name as a site name. The column for the site name 1913 displays the second hierarchical level group name as a site name. The column for the managed device number 1914 displays the managed device number for each site name 1913. The column for Type A ratio 1915 displays the ratio of the device number in which a model is Type A relative to the managed device number for each site name 1913. The column for Type B ratio 1916 displays the ratio of the device number in which a model is Type B relative to the managed device number for each site name 1913. The column for Type C ratio 1917 displays the ratio of the device number in which a model is Type C relative to the managed device number for each site name 1913.

The tenant type of ABC USA is company, the tenant type of Seattle is site (one site of the ABC USA company), and therefore the tenant type is different. However, in the present function, the information for Seattle is displayed as ABC USA information. This is due to the fact that Seattle is treated as a tenant for the benefit of the service provider, and must not be distinguished in the display in relation to a function that is used by a customer to peruse information by site for each company. Furthermore, Seattle is displayed in the first hierarchical level for the sites in ABC USA. This is due to the fact that Seattle is originally handled in the same manner as other sites such as New York or Virginia in ABC USA. Therefore, in the present function that is used by a customer to peruse information by site for each company, it is necessary to display in the same hierarchical level as other sites of ABC USA. That is to say, the present function is not adapted by group unit by tenant but rather is adapted for list display of a site unit by company.

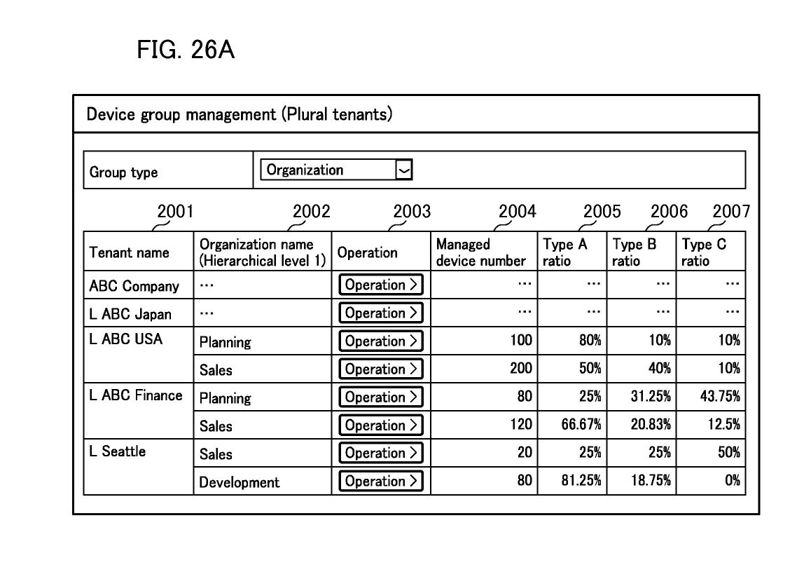

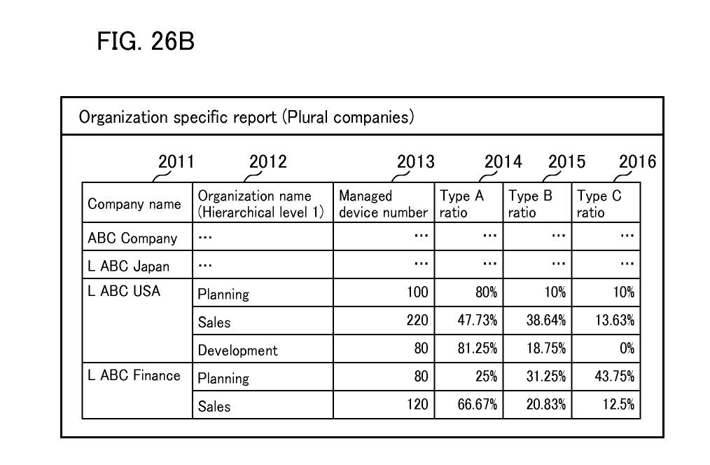

FIG. 26A illustrates an example of a group list display for a device group (organization) management function for a plurality of tenants having a list ID of 5 in the list information table illustrated in FIG. 12. The present function envisages use for a service provider to manage the group of each tenant. The service provider selects and operates the group by use of the present function.

The device group managing screen example illustrated in FIG. 26A is configured by a tenant name 2001 to Type C ratio 2007. In FIG. 26A, the column of the tenant name 2001 displays the name of each tenant. The column of the organization name 2002 displays a first hierarchical level group name as the organization name. The column for the operation 2003 displays an operation button that transitions to a function of operating the group. The column for the managed device number 2004 displays the managed device number in the group. The column for Type A ratio 2005 displays the ratio of the device number in which a model is Type A relative to the managed device number in the organization name 2002. The column for Type B ratio 2006 displays the ratio of the device number in which a model is Type B relative to the managed device number in the organization name 2002. The column for Type C ratio 2007 displays the ratio of the device number in which a model is Type C relative to the managed device number in the organization name 2002.

The tenant type of ABC USA is company, the tenant type of Seattle is site (one organization of the ABC USA company), and therefore the tenant type is different. As a result, in the present function, ABC USA and Seattle are distinguished when displayed. This is due to the fact that a service provider must manage by tenant unit. That is to say, in the present function, the list display is adapted to a group unit by tenant.

FIG. 26B illustrates an example of a group list display for a report function by organization for a plurality of tenants having a list ID of 10 in the list information table illustrated in FIG. 12. The present function envisages use for the purpose of a customer perusing information by organization for each company.

The organization specific report example illustrated in FIG. 26B is configured from a company name 2011 to the Type C ratio 2016. In FIG. 26B, the column of the company name 2011 displays the tenant name as a company name. The column for the organization name 2012 displays the first hierarchical level group name as an organization name. The column for the managed device number 2013 displays the managed device number in the group. The column for Type A ratio 2014 displays the ratio of the device number in which a model is Type A relative to the managed device number in hierarchical level 1. The column for Type B ratio 2015 displays the ratio of the device number in which a model is Type B relative to the managed device number in hierarchical level 1. The column for Type C ratio 2016 displays the ratio of the device number in which a model is Type C relative to the managed device number in hierarchical level 1.

The tenant type of ABC USA is company, the tenant type of Seattle is site (one organization of the ABC USA company), and therefore the tenant type is different. However, in the present function, the information for Seattle is displayed as ABC USA information. For example, the managed device number 2013 of Sales in ABC USA is the total of the managed device number of Sales in ABC USA and the managed device number of Sales in Seattle. This is due to the fact that Seattle is treated as a tenant for the benefit of the service provider, and must not be distinguished in the display in relation to a function that is used by a customer to peruse information for each company. That is to say, the present function is not adapted with reference to group unit by tenant but rather is adapted to display a list of organization units by company. As described above, the managing server system of the present invention is enabled to generate a list using a suitable unit in response to a function of a provided service.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-211163, filed on Oct. 8, 2013, which is hereby incorporated by reference herein in its entirety.

What is claimed is:

1. A managing server system configured to manage operational information of a network device that is installed on a customer network, the managing server system comprising:
a managing unit configured to manage each of a plurality of groups, that belong to the customer, by a tenant, and
a setting unit configured to set whether an object to be processed is a tenant unit or a group unit in relation to each of a plurality of functions provided by the managing server system,
wherein the managing unit manages a site that belongs to one group of the plurality of groups by a tenant that is different from the group, and
wherein, in accordance with the setting, the site that is managed as the tenant is not the object to be processed in a function in which the object to be processed is the group unit, otherwise the site that is managed as the tenant is the object to be processed in a function in which the object to be processed is the tenant unit.

2. The managing server system according to claim 1, further comprising:
an output unit configured, in accordance with the setting, to not output to a list the site that is managed as the different tenant in the function in which the object to be processed is the group unit, otherwise to output to the list the site that is managed by the different tenant in the function in which the object to be processed is a tenant unit.

3. The managing server system according to claim 1, wherein the managing unit manages the group by use of a hierarchical structure, and when the site belonging to one group in the plurality of groups is managed by a tenant that is different from the group, the different tenant is managed as a subordinate tenant to the tenant for the group.

4. The managing server system according to claim 3, wherein the output unit does not output the site to the list by processing the site as a superordinate tenant that is managed as the subordinate tenant in the function in which the object to be processed is a group unit, and outputs each tenant to the list so that the subordinate tenant is displayed in distinction from the superordinate tenant in the function in which the object to be processed is the tenant unit.

5. The managing server system according to claim 3, wherein when a consignment of a service is requested in relation to a site that belongs to one group or any of the groups in the plurality of groups, the managing unit manages the different tenant as a subordinate tenant to the tenant for the group.

6. The managing server system according to claim 5, wherein, for a site which is further subordinate to the site which a tenant type is changed as the subordinate tenant, the managing unit changes the tenant type of the subordinate site in accordance with the change.

7. The managing server system according to claim 4, wherein, when the customer requests the operational information in relation to the network device on the network of the customer, the output unit does not output the site to a list by including the site managed as the subordinate tenant in the superordinate tenants, and when a service provider that manages the network device of the customer requests the operational information in relation to the network device, the output unit outputs the each tenant to the list so that the subordinate tenant is displayed in distinction from the superordinate tenant.

8. A control method for a managing server system configured to manage operational information of a network device that is installed on a customer network, the method comprising:
managing each of a plurality of groups, that belong to the customer, by a tenant, and setting whether an object to be processed is a tenant unit or a group unit in relation to each of a plurality of functions provided by the managing server system,
wherein, in the managing, a site that belongs to one group of the plurality of groups is managed by a tenant that is different from the group, and
wherein, in accordance with the setting, the site that is managed as the tenant is not the object to be processed in a function in which the object to be processed is the group unit, otherwise the site that is managed as the tenant is the object to be processed in a function in which the object to be processed is the tenant unit.
